(19) United States
(12) Patent Application Publication
(10) Pub. No.: US 2019/0051210 A1
(43) Pub. Date: Feb. 14, 2019

(54) DISTRIBUTED ARCHITECTURE FOR DATA SYNCHRONIZATION

(71) Applicant: Inchstones, LLC, Phoenix, AZ (US)

(72) Inventor: Gregg Bookspan, Phoenix, AZ (US)

(73) Assignee: Inchstones, LLC, Phoenix, AZ (US)

(21) Appl. No.: 16/056,719

(22) Filed: Aug. 7, 2018

Related U.S. Application Data
(60) Provisional application No. 62/543,169, filed on Aug. 9, 2017.

(51) Int. Cl. G09B 19/00; G06F 17/30

(52) U.S. Cl. CPC G09B 19/00; G09B 21/001; G06F 17/30575

(57) ABSTRACT

Methods, systems, and articles of manufacture having a non-transitory, tangible computer readable storage medium for planning and tracking progress of educational goals are disclosed herein. The present disclosure compares services and treatments provided to a student to an educational plan specifically prepared for the student. The system may utilize standardized incremental subgoals in order to measure progress toward a higher level educational goal.

### CROSS REFERENCE TO RELATED APPLICATIONS

This application claims priority to and the benefit of, U.S. Provisional Patent Application No. 62/543,169, filed on Aug. 9, 2017 and entitled “DISTRIBUTED ARCHITECTURE FOR DATA SYNCHRONIZATION,” which is hereby incorporated by reference for all purposes.

### FIELD

This disclosure relates to systems and methods for distributed computing devices.

### BACKGROUND

Children with disabilities are guaranteed a “free and appropriate public education” under the Individuals with Disabilities Education Act (the “IDEA”). The IDEA requires that school districts develop Individualized Education Plans (“IEPs”) for children with disabilities that are reasonably calculated to enable a child to make progress appropriate in light of the child's circumstances.

“[T]he essential function of an IEP is to set out a plan for pursuing academic and functional advancement. . . . This reflects the broad purpose of the IDEA, an “ambitious” piece of legislation enacted “in response to Congress’ perception that a majority of handicapped children in the United States ‘were either totally excluded from schools or [were] sitting idly in regular classrooms awaiting the time when they were old enough to ‘drop out.” Rowley, 458 U.S., at 179 (quoting H. R. Rep. No. 94-332, p. 2 (1975)). . . . When all is said and done, a student offered an educational program providing ‘merely more than de minimis’ progress from year to year can hardly be said to have been offered an education at all. For children with disabilities, receiving instruction that aims so low would be tantamount to ‘sitting idly . . . awaiting the time when they were old enough to ‘drop out.” Rowley, 458 U.S., at 179 (some internal quotation marks omitted). The IDEA demands more.” Endrew F. v. Douglas County School District, 580 U.S. ______ (2017) [emphasis added].

However, tracking a child's progress against the goals set forth in the IEP has been problematic.

Historically, many children with disabilities were institutionalized. Today, in many cases, it has been found to be more effective to integrate children with disabilities into their local school districts so they may learn with their peers, albeit supported by specialized programs, instruction, and other skilled services. Providing such services in this distributed manner may prove difficult, given the limited resources of certified, skilled staff and travel limitations. For example, a blind student may have a teacher of the visually impaired (a “TVI”) and a teacher of orientation and mobility (an “O&M instructor”). The TVI and O&M instructor may deliver services at different times, and may even be employed by different providers. Too often, communication regarding student progress may not occur effectively between two disparate providers.

Many children with disabilities can grow up to be, with the right education and accommodation, self-sufficient and productive members of society. Where this outcome may not be possible to achieve, educators can often teach these children to be self-determinative. In that regard, the appropriate delivery of special education is important to giving children with disabilities the skills they will need as adults.

### SUMMARY

A method in accordance with the present disclosure may comprise receiving, by a processor and from a mobile device, a first service event data comprising a first service event, a first geographic location, and a first duration; parsing, by the processor, the first service event data to a first educational plan, wherein the first educational plan comprises a plurality of treatment steps to reach an educational goal, and wherein the first educational plan is stored in an educational plan relational database and is associated with a first student, wherein the parsing identifies a potential first service event; creating, by the processor, a metadata field for the potential first service event; linking, by the processor, the metadata field with a step in the potential first service event to identify the first service event; associating, by the processor, the first service event of the first service event data with one or more of the plurality of treatment steps of the first educational plan; receiving, by the processor, a second service event data comprising a second service event, a second geographic location, and a second duration; linking, by the processor, the second service event data to a second educational plan; and associating, by the processor, the second service event of the second service data with one or more of a plurality of treatment steps of the second educational plan. The step of receiving the first service event data may comprise entering, at the mobile device, at least one of the first service event and the first duration in to a first mobile device, and transmitting, by the first mobile device, the first service event data to the processor. The first service event data may further comprise a service note created by a service provider. The first geographic location of the first service event data may be determined by a component of a first mobile device. The parsed data may identify the potential first service event derived from a calendar. The first service event may comprise at least one of a therapeutic treatment or an instructional event. The method may further comprise authenticating, by the processor, a service provider account. The service provider may comprise an itinerant service provider, a classroom instructor, a physician, a nurse practitioner, a nurse, a teacher of the visually impaired, a teacher of the deaf, a physical therapist, or an occupational therapist.

Another method in accordance with the present disclosure may comprise receiving, by a processor of a first mobile device, a geographic data and a time data; determining, by the processor, a proposed treatment event from the geographic data and the time data based upon a first educational plan; confirming, by the processor, the proposed treatment event to create a confirmed treatment event via a service provider; comparing, by the processor, the confirmed treatment event to a plurality of treatments of the first educational plan; updating, by the processor, the first educational plan to include the confirmed treatment event; and creating, by the processor, a medical billing data from the confirmed treatment event. The time data may comprise a duration data and a time stamp. The confirmed treatment event may comprise at least one of a treatment note and an educational outcome created by the service provider. The geographic data may be determined via a global positioning system of the first mobile device. The step of determining a proposed treatment event may comprise comparing the geographic data and the time data to a schedule stored on the first mobile device. The confirmed treatment event may comprise at least one of a therapeutic treatment or an instructional event. The method may further comprise transmitting, by the processor, a service provider data to a server, wherein the service provider data comprises a service provider user identity. The method may further comprise authenticating, by the processor, the service provider user identity. The service provider may be one of a physicians, an itinerant service provider, a classroom instructor, a physician, a nurse practitioner, a nurse, a teacher of the visually impaired, a teacher of the deaf, a physical therapist, or an occupational therapist.

Yet another method in accordance with the present disclosure may comprise receiving, by a first mobile device, a first service event data comprising a first geographic location, and a first duration; transmitting, by the first mobile device, the first service event data from the first web application of the first mobile device to an application server; determining, by the application server, from the first service event data, a first proposed treatment event; confirming, by the first mobile device, the first proposed treatment event to create a first confirmed treatment event; comparing the first confirmed treatment event to a first educational plan, wherein the first educational plan comprises a plurality of treatment steps to reach a treatment goal, and wherein the first educational plan is stored in an educational plan relational database and is associated with a first student; associating, by the application server, the first confirmed treatment event with one or more of the plurality of treatment steps of the first educational plan; updating, by the application server, the first educational plan to include the first confirmed treatment event; and creating, by the application server, a first medical billing data from the first confirmed treatment event.

A system in accordance with the present disclosure may comprise a processor, a tangible, non-transitory memory configured to communicate with the processor, the tangible, non-transitory memory having instructions stored thereon that, in response to execution by the processor, cause the processor to perform operations comprising: receiving, by a processor and from a mobile device, a first service event data comprising a first service event, a first geographic location, and a first duration; parsing, by the processor, the first service event data to a first educational plan, wherein the first educational plan comprises a plurality of treatment steps to reach an educational goal, and wherein the first educational plan is stored in an educational plan relational database and is associated with a first student, wherein the parsing identifies a potential first service event; creating, by the processor, a metadata field for the potential first service event; linking, by the processor, the metadata field with a step in the potential first service event to identify the first service event; associating, by the processor, the first service event of the first service event data with one or more of the plurality of treatment steps of the first educational plan; receiving, by the processor, a second service event data comprising a second service event, a second geographic location, and a second duration; linking, by the processor, the second service event data to a second educational plan; and associating, by the processor, the second service event of the second service data with one or more of a plurality of treatment steps of the second educational plan. The first service event data may further comprise a service note created by a service provider. The first geographic location of the first service event data may be determined automatically by a component of a first mobile device. The operations may further comprise authenticating, by the processor, a service provider account. The parsed data may identify the potential first service event derived from a calendar. The service provider may comprise a physician, an itinerant service provider, a classroom instructor, a physician, a nurse practitioner, a nurse, a teacher of the visually impaired, a teacher of the deaf, a physical therapist, or an occupational therapist. The first service event may comprise at least one of a therapeutic treatment or an instructional event.

An article of manufacture in accordance with the present disclosure may comprise a non-transitory, tangible computer readable storage medium having instructions stored thereon that, in response to execution by a computer based system, cause the computer based system to perform operations comprising: receiving, by the computer based system, a first service event data comprising a first service event, a first geographic location, and a first duration; comparing, by the computer based system, the first service event data to a first educational plan, wherein the first educational plan comprises a plurality of treatment steps to reach a treatment goal, and wherein the first educational plan is stored in an educational plan relational database and is associated with a first student; associating, by the computer based system, the first service event of the first service event data with one or more of the plurality of treatment steps of the first educational plan; receiving, by the computer based system, a second service event data comprising a second service event, a second geographic location, and a second duration; comparing, by the computer based system, the second service event data to a second educational plan; and associating, by the computer based system, the second service event of the second service data with one or more of a plurality of treatment steps of the second educational plan. The first service event data may further comprise a service note created by a service provider. The service provider may comprise an itinerant service provider, a classroom instructor, a physician, a nurse practitioner, a nurse, a physical therapist, and an occupational therapist. The first geographic location of the first service event data may be determined automatically by a component of a first mobile device. The operations may further comprise comparing, by the computer based system, the first service event data to a schedule.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

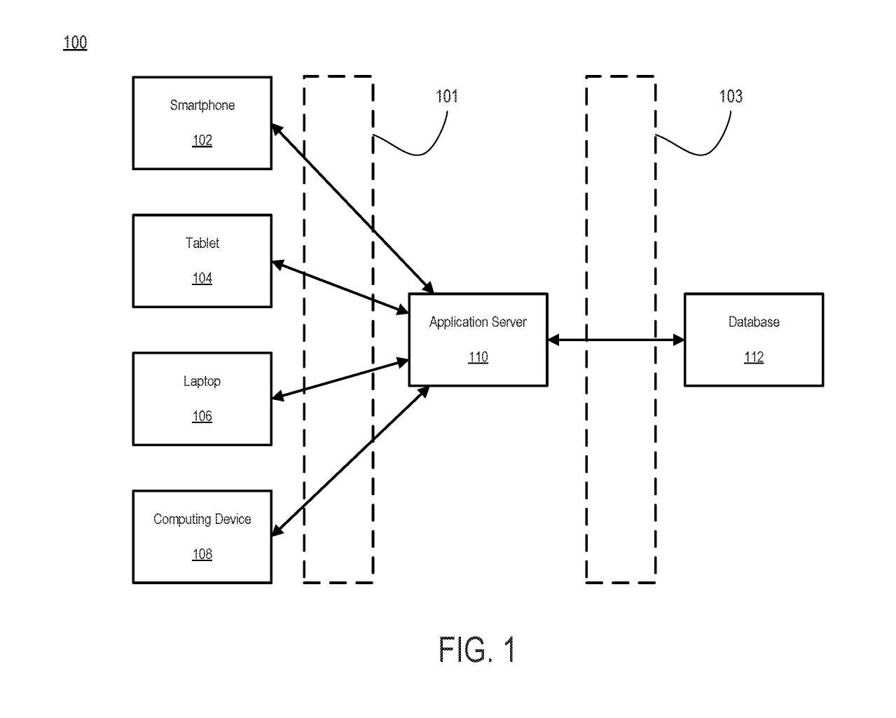

FIG. 1 illustrates a distributed system for distribution of planning, delivering, and monitoring interactions with an individual student and/or patient, in accordance with various embodiments;

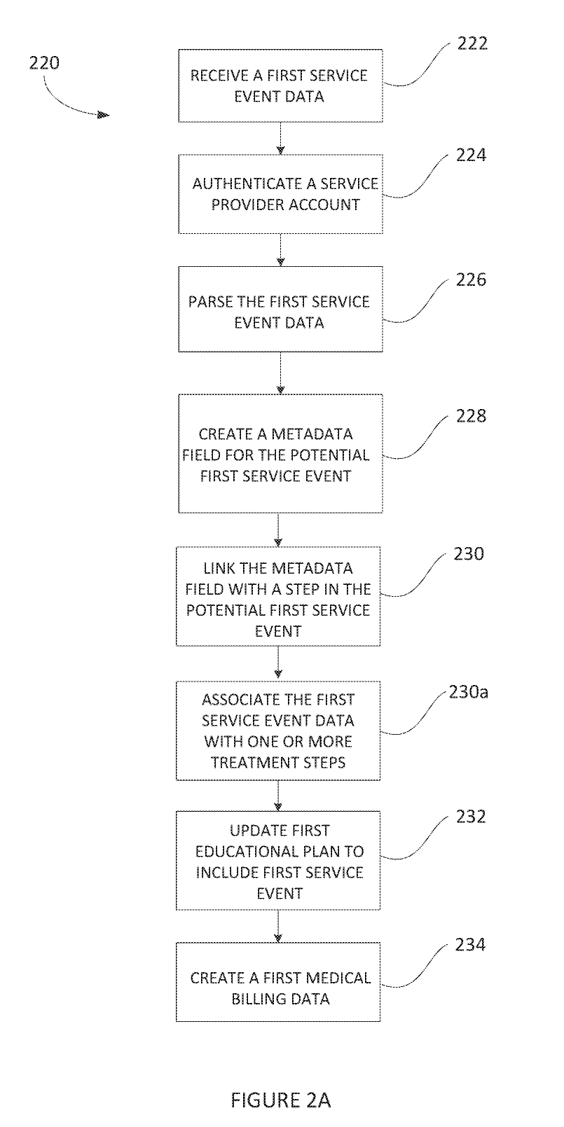

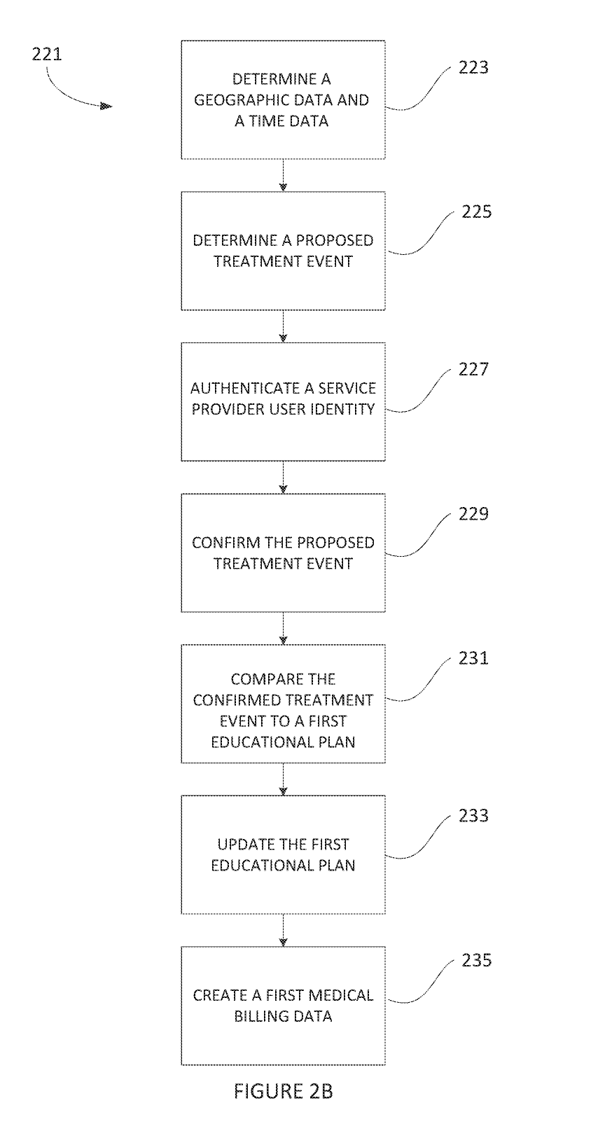

FIG. 2A illustrates a process for distribution of planning, delivering, and monitoring interactions with individual student and/or patient, in accordance with various embodiments;

FIG. 2B illustrates another process for distribution of planning, delivering, and monitoring interactions with individual student and/or patient, in accordance with various embodiments;

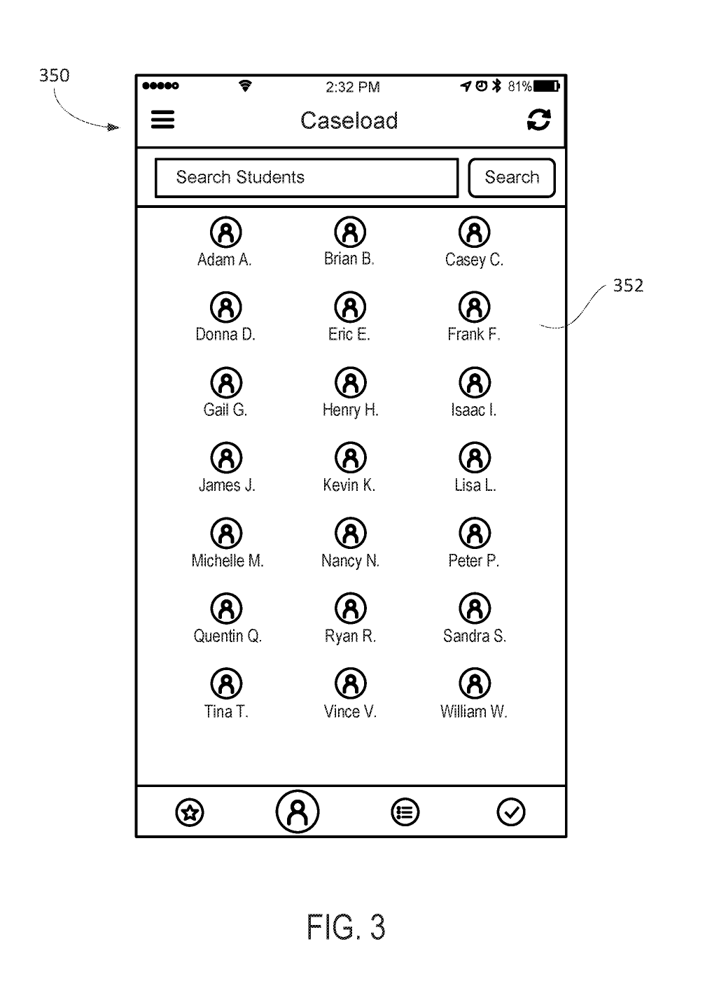

FIG. 3 illustrates an interface for identifying students and/or patients assigned to a service provider, in accordance with various embodiments;

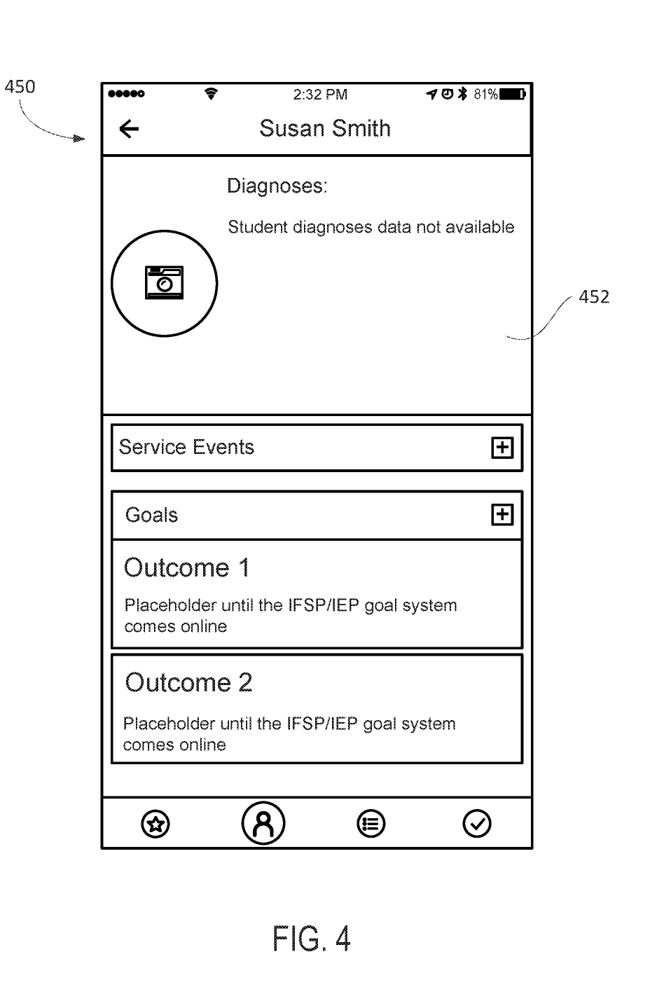

FIG. 4 illustrates an interface for reviewing diagnoses, service events, or goals for an individual student and/or patient, in accordance with various embodiments;

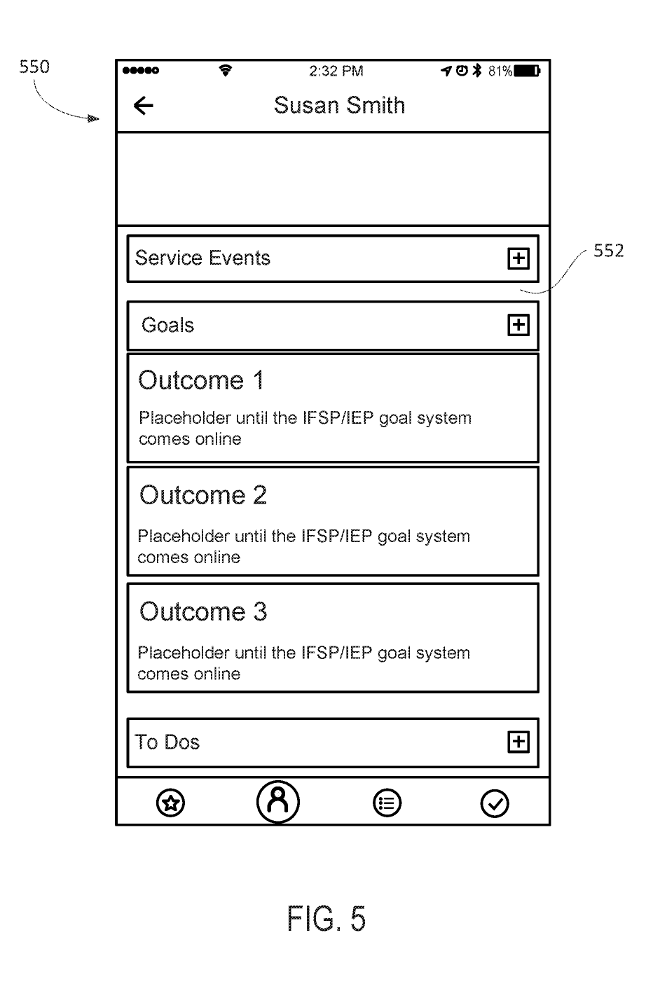

FIG. 5 illustrates an interface for reviewing diagnoses, service events, goals, or “to dos” for an individual student and/or patient, in accordance with various embodiments;

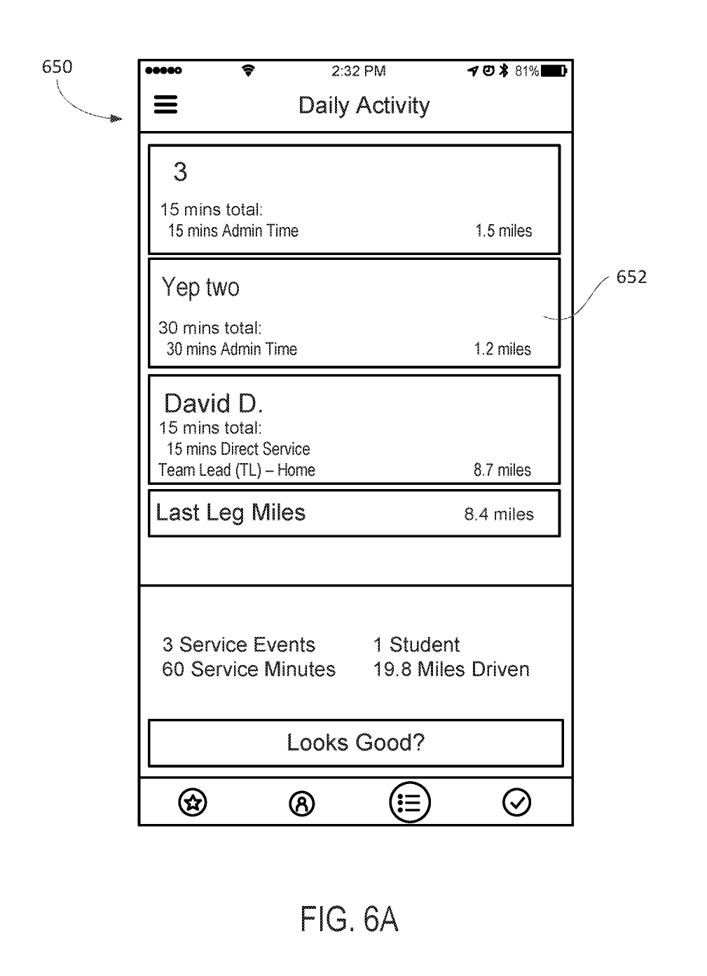

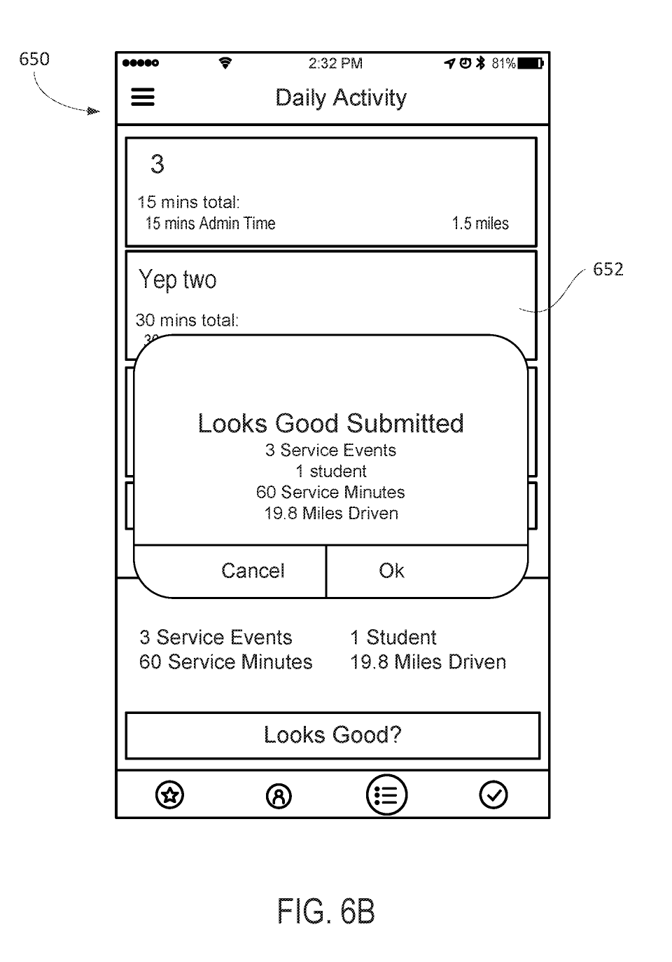

FIG. 6A illustrates an interface for planning daily activity of a service provider, student, and/or patient, in accordance with various embodiments;

FIG. 6B illustrates a confirmation page for daily activity of the service provider, student, and/or patient, in accordance with various embodiments;

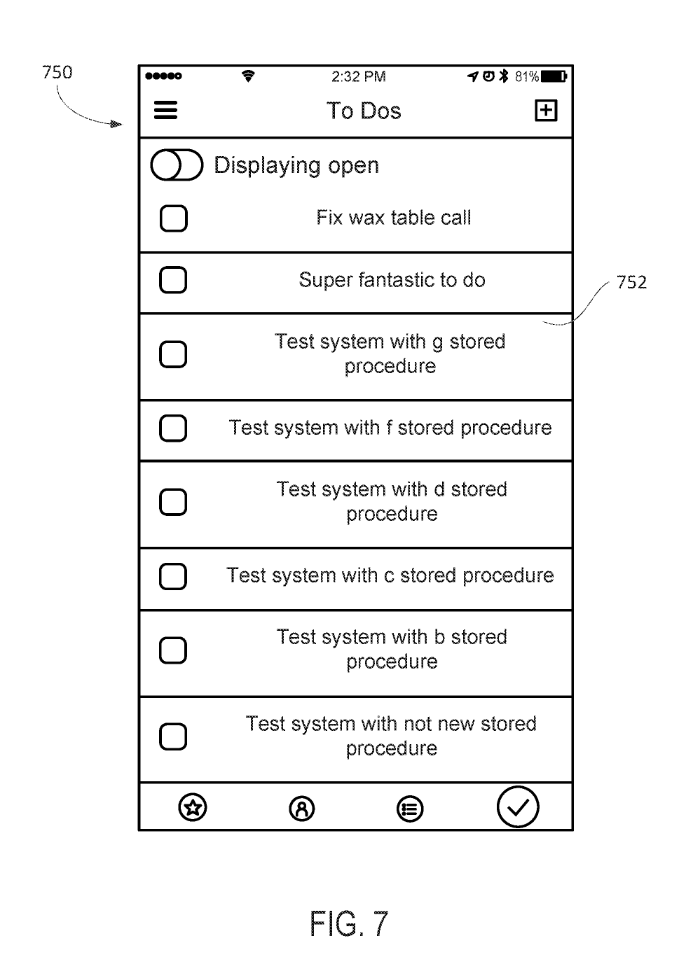

FIG. 7 illustrates an interface for a service provider to interact with a “to do” list, in accordance with various embodiments;

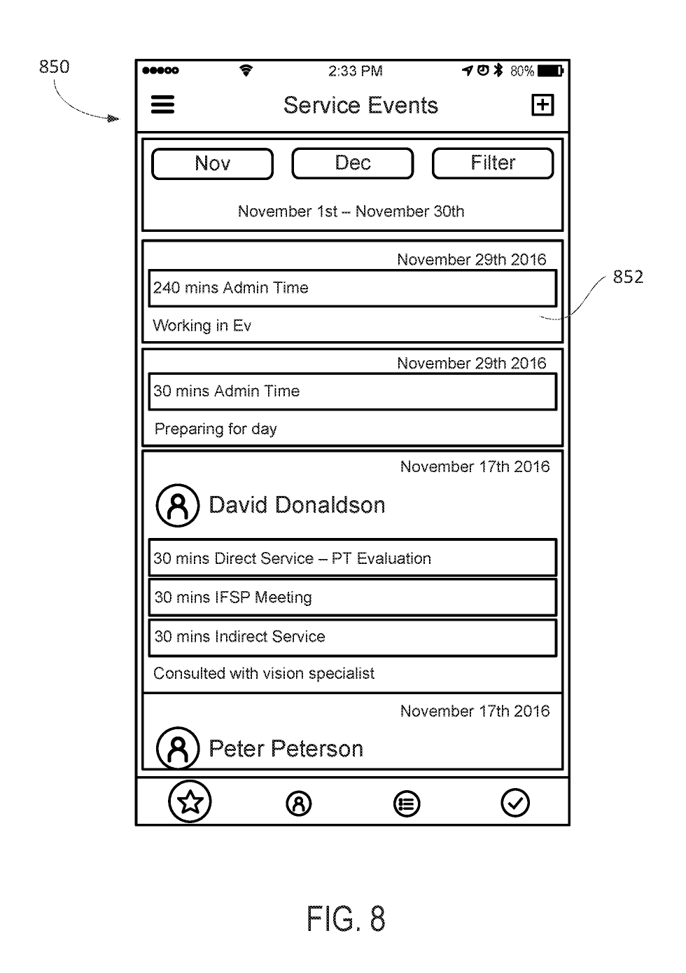

FIG. 8 illustrates an interface for a service provider to track service events with students and/or patients, in accordance with various embodiments;

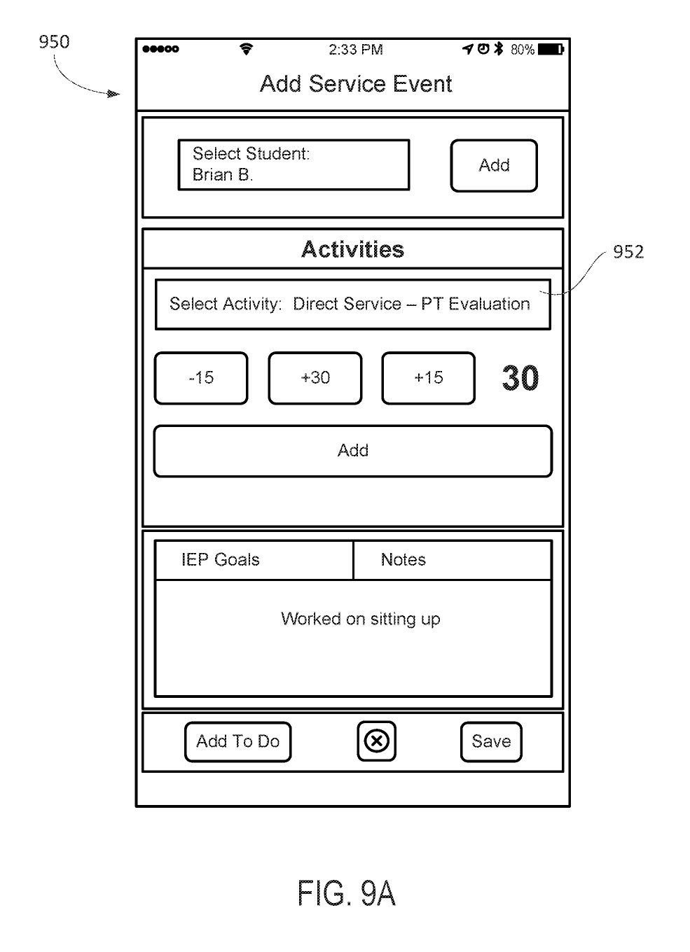

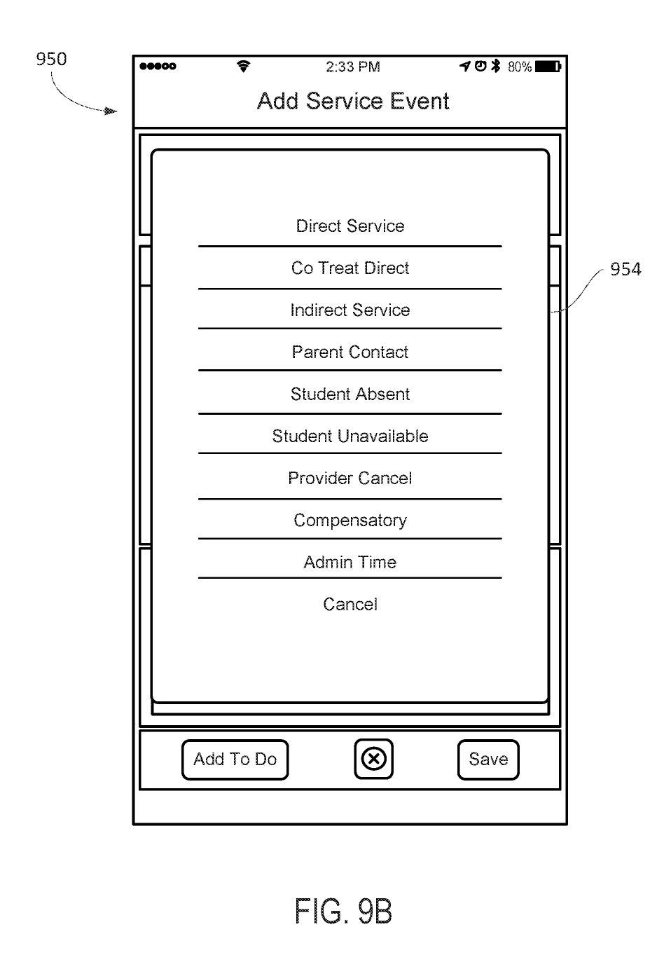

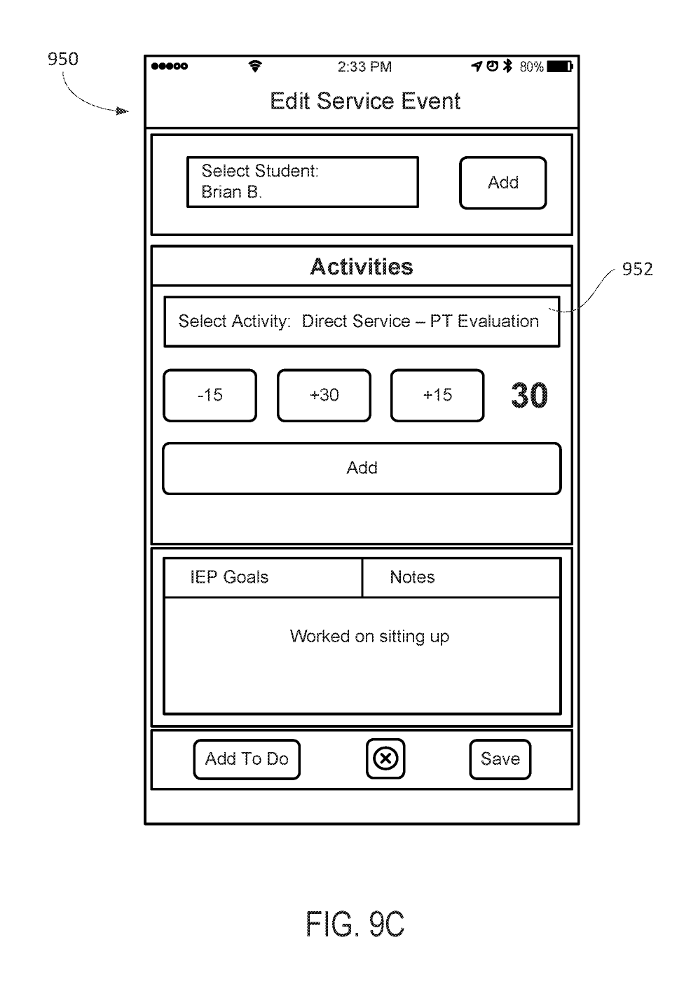

FIG. 9A illustrates an interface for a service provider to create service events scheduled with students and/or pupils, in accordance with various embodiments;

FIG. 9B illustrates an interface for a service provider to select a type of service event, in accordance with various embodiments;

FIG. 9C illustrates an interface for a service provider to edit a service event, in accordance with various embodiments;

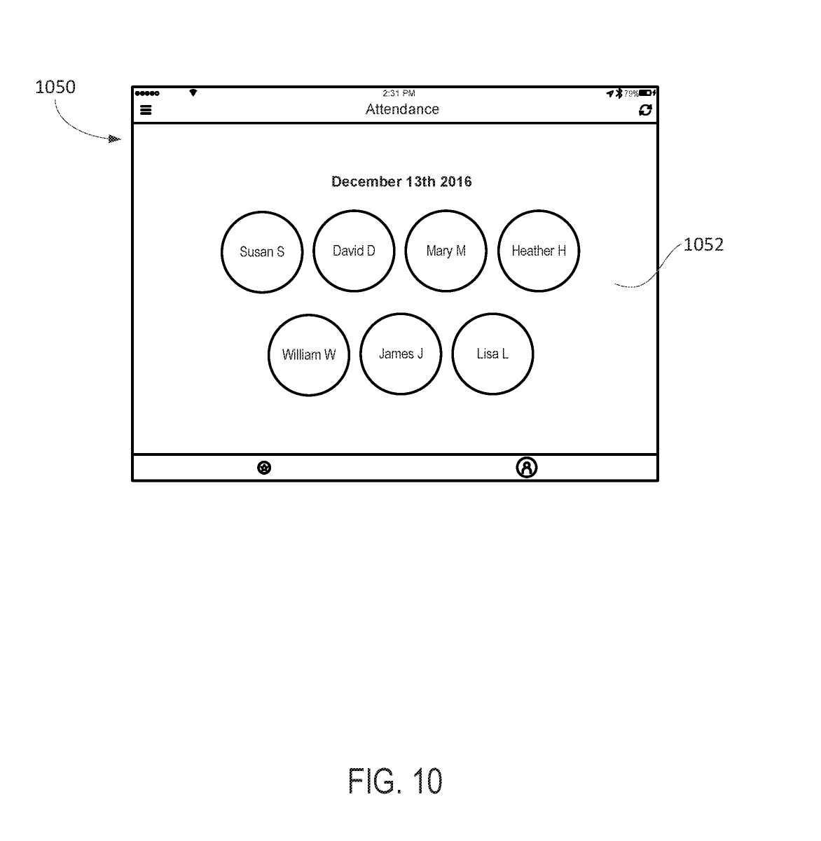

FIG. 10 illustrates an interface for planning classes with multiple students and/or patients, in accordance with various embodiments;

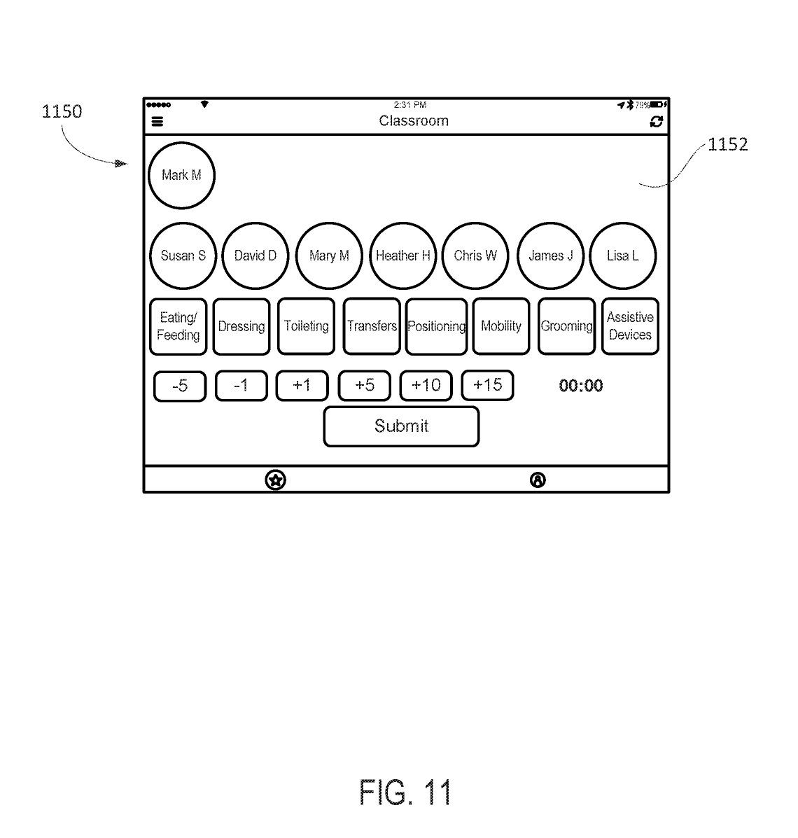

FIG. 11 illustrates an interface for tracking attendance of students and/or patients and group classes, in accordance with various embodiments;

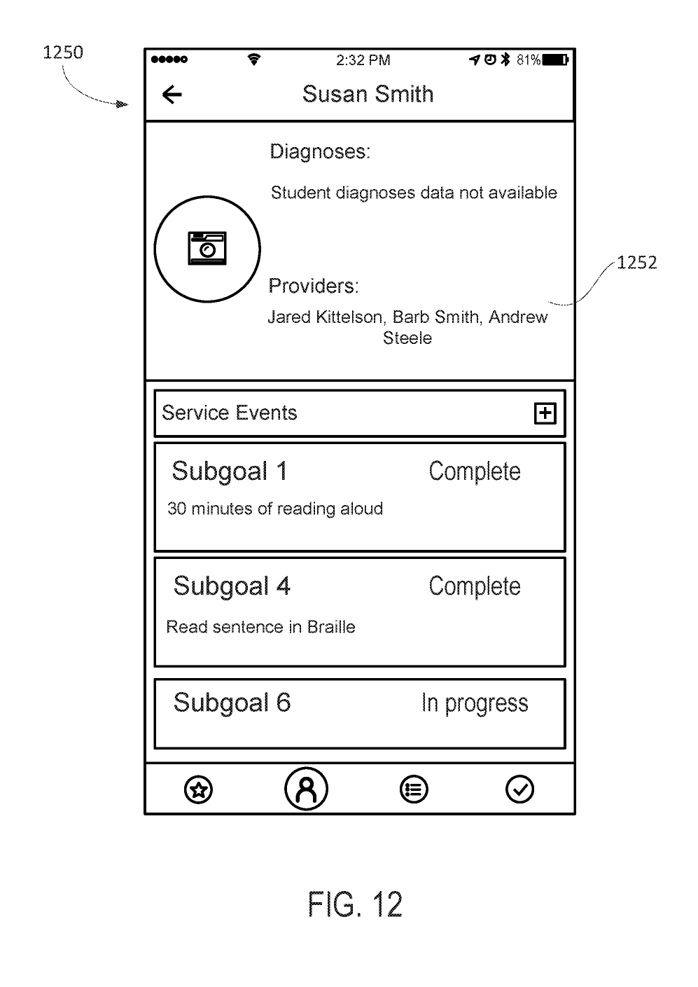

FIG. 12 illustrates an interface for viewing a student summary report, in accordance with various embodiments;

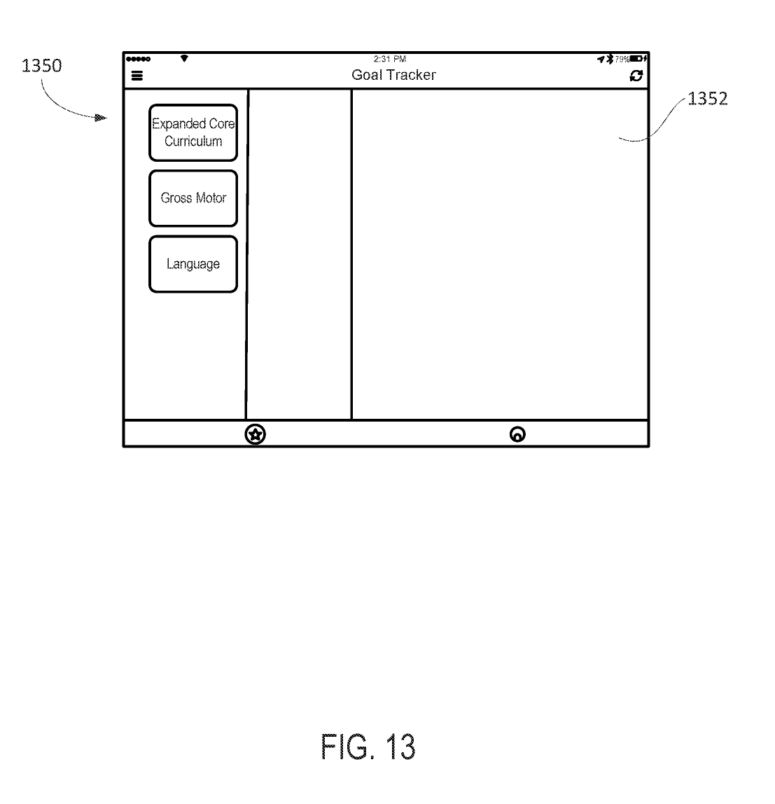

FIG. 13 illustrates an interface for updating and tracking subgoals for students and/or patients, in accordance with various embodiments;

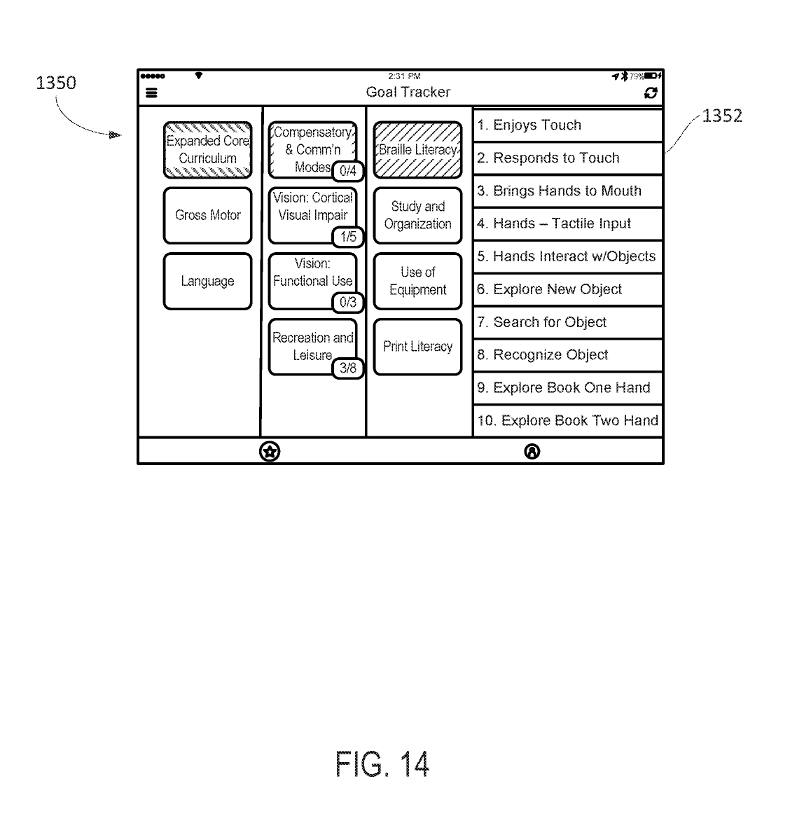

FIG. 14 illustrates an interface with a goal selected, in accordance with various embodiments;

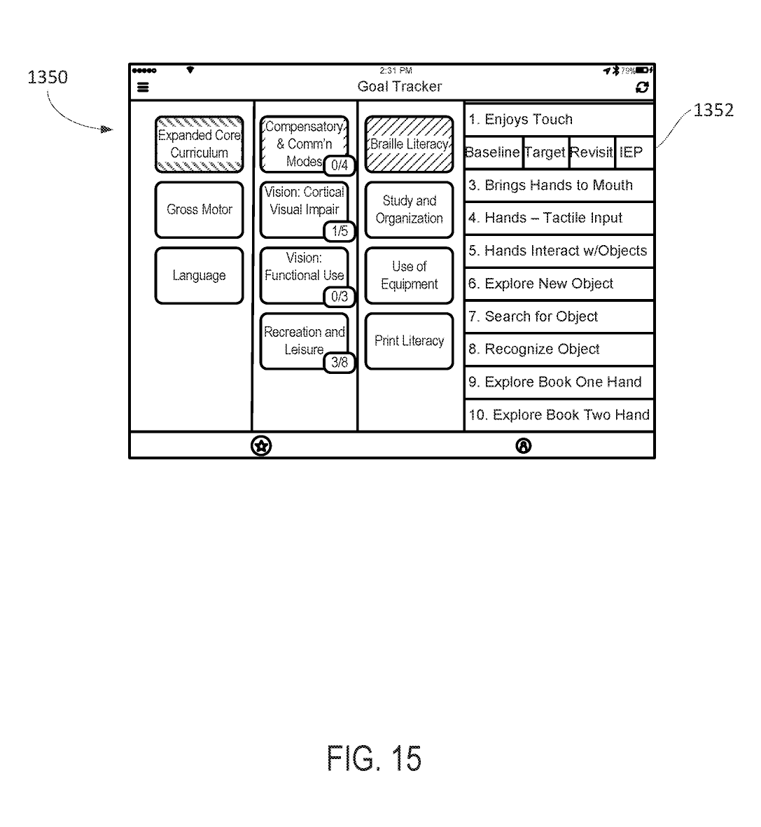

FIG. 15 illustrates an interface with a subgoal selected, in accordance with various embodiments;

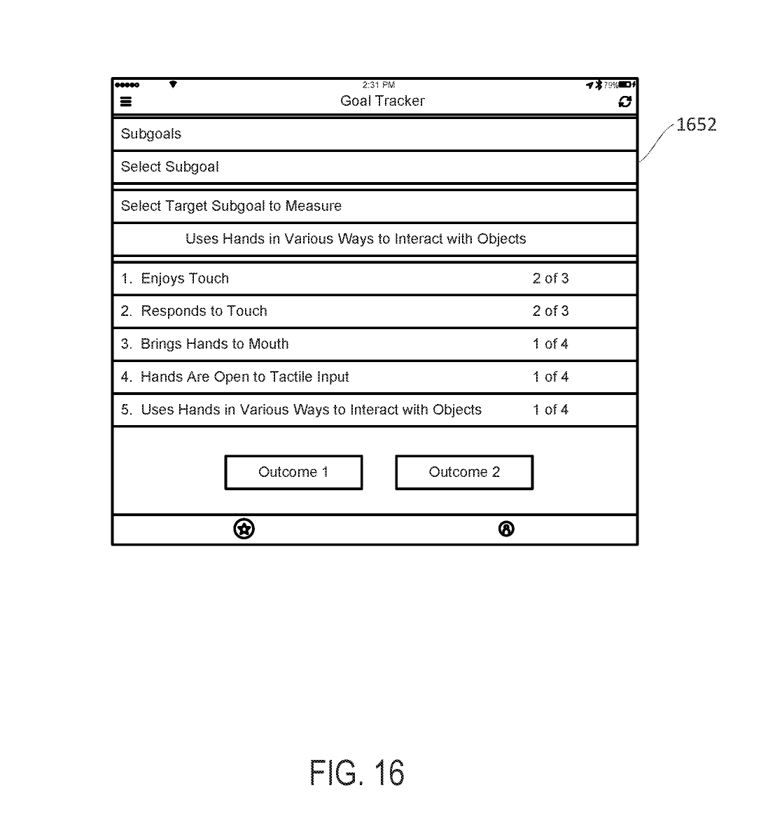

FIG. 16 illustrates an interface for updating a student's progress through the subgoals, in accordance with various embodiments;

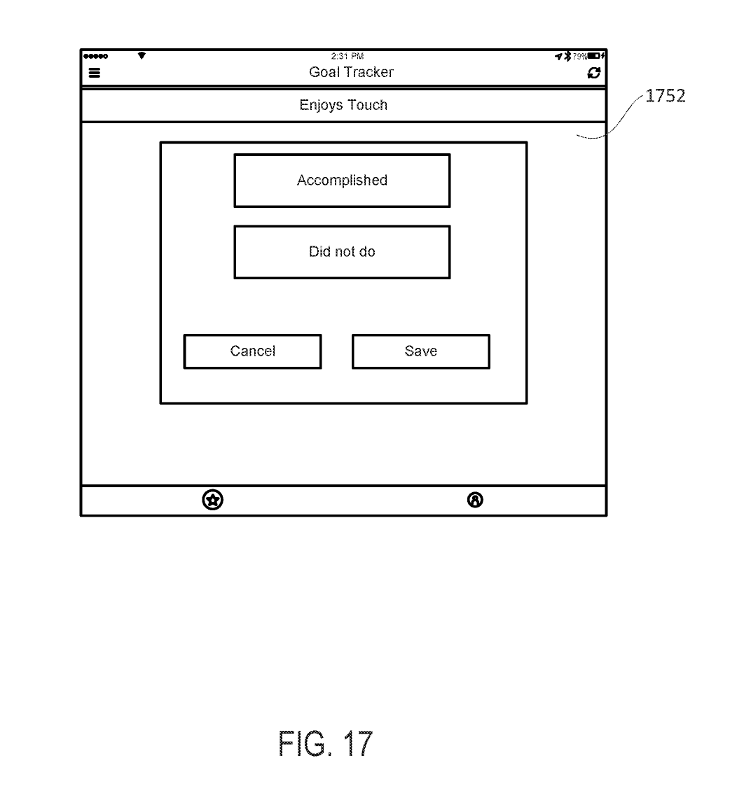

FIG. 17 illustrates an interface for updating a subgoal, in accordance with various embodiments;

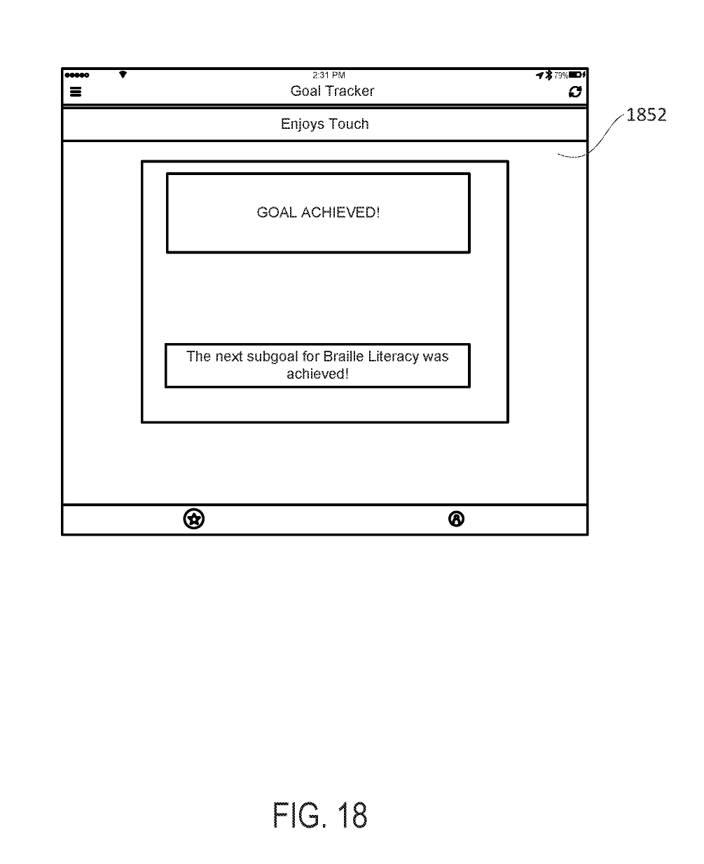

FIG. 18 illustrates an interface indicating that a subgoal has been achieved, in accordance with various embodiments;

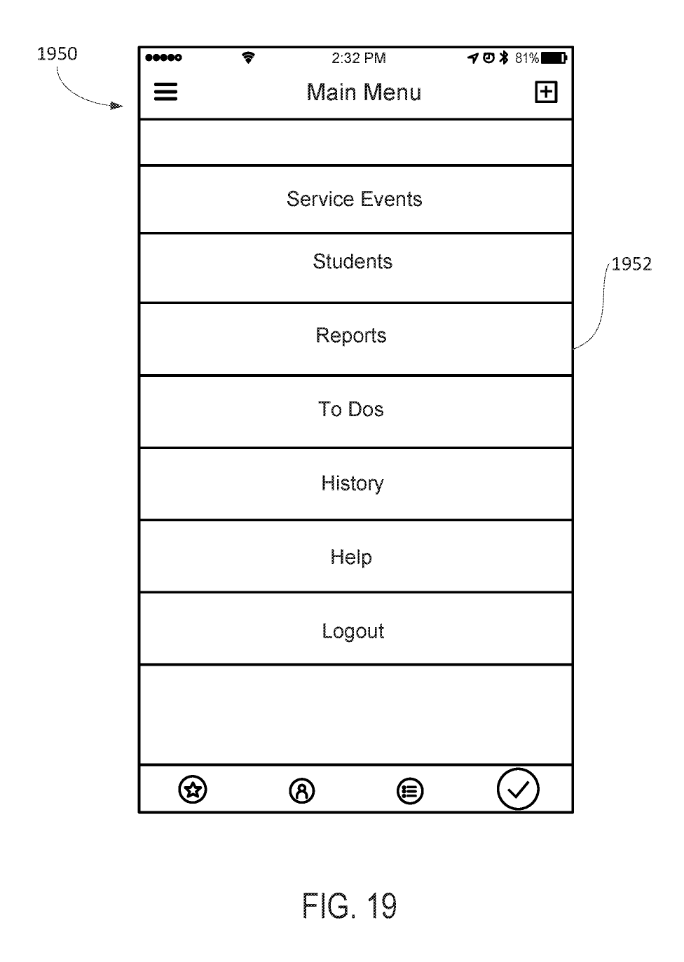

FIG. 19 illustrates an interface for a main menu, in accordance with various embodiments;

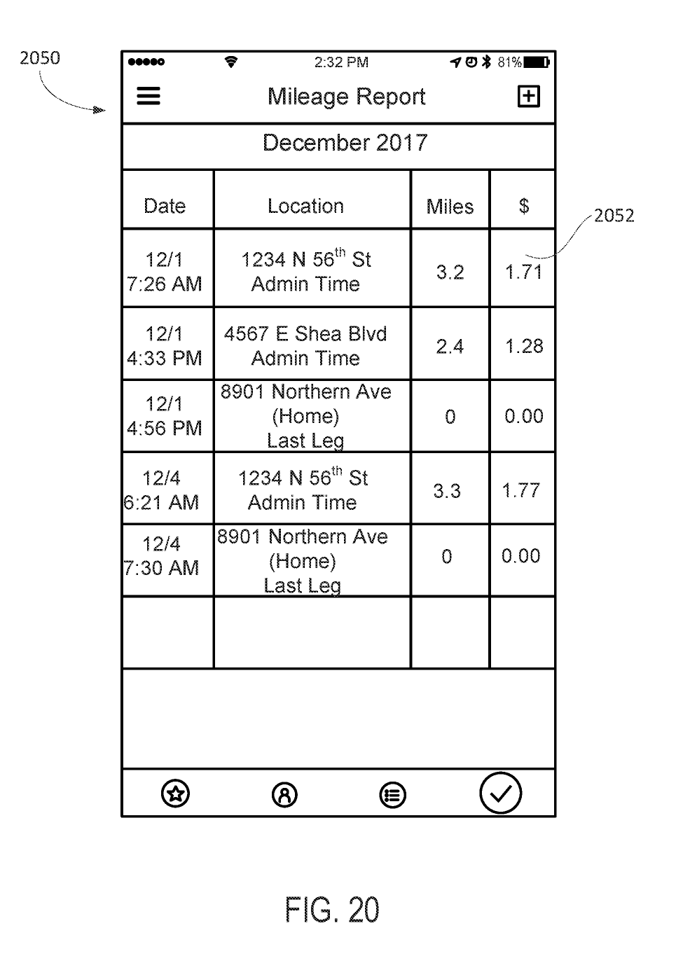

FIG. 20 illustrates an interface for viewing a monthly mileage report, in accordance with various embodiments.

### DETAILED DESCRIPTION

The detailed description of various embodiments herein refers to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

The present disclosure provides systems, methods, and computer program products for synchronizing services, treatments, and educational plans across various service providers. Any number of service providers such as instructors, physicians, an itinerant service provider, a classroom instructor, a physician, a nurse practitioner, a nurse, a teacher of the visually impaired, a teacher of the deaf, a physical therapist, and an occupational therapist, or other service providers may maintain coordinated and synchronous communications, updates, requests, and reports on individual patients or students. Each service provider may access the synchronized data pertaining to their patients or students in real-time. Access controls may restrict unauthorized access to sensitive and/or personally identifiable information. The improved communication and structured presentation of each student's information results in more tailored and more effective course work and care provided to the students.

In that regard, in various embodiments, the present disclosure allows for effective management, coordination, and collaboration of special education providers. For example, in various embodiments, the present disclosure allows for special education providers who provide service across multiple school districts to collaborate regarding a child's educational, medication, and special needs. Moreover, in various embodiments, parents may be able to more effectively monitor a child's educational progress, especially over time as a child may change schools or schools districts throughout childhood and young adulthood. In addition, in various embodiments, the security of data pertaining to students and service providers is enhanced. For example, in various embodiments, data may be encrypted both while stored on devices (as described further below) and on a server or cloud based solution, such that in the event of misappropriation of data, only encrypted files would be lost, and thus would be unreadable without the proper cryptographic keys. In various embodiments, data transmission between devices and/or a server and/or a cloud based solution may be encrypted. Such data transmission encryption could utilize SSL, TLS, VPN technologies, PGP encryption, and other transmission encryption methods to ensure data security while traveling over public networks such as the Internet. Moreover, in various embodiments, permission based access and access logs may be used to segregate data from various users so that only qualified users gain access to such data. In various embodiments, data used herein may be regulated by federal and state laws, such as the Health Insurance Portability and Accountability Act (“HIPAA) and Family Educational Rights and Privacy Act (“FERPA”), and such encryption and access restriction methods may be used to render various embodiments compliant with HIPAA and/or FERPA.

The system may take educational goals and break them down into standardized granular subgoals. Thus, for a high level goal, such as Braille Literacy, the system may include a list of hundreds or thousands of subgoals required in order to achieve Braille Literacy. For a given student, the system may stores goals and subgoals based on an IEP created for the student. The system may track the progress of the student through the goals and subgoals. Each different service provider may track students using the standardized granular subgoals, which may decrease subjectivity in evaluation of a student's progress. Additionally, students, service providers, and parents may all be able to see concrete evidence of progress as a student completes subgoals on their way to completing a larger goal.

With reference to FIG. 1, system 100 is shown having distributed computing systems in electronic and/or logical communication to coordinate information pertaining to individual students and/or patients, in accordance with various embodiments. System 100 comprises various computing devices running applications in communication across various networks. Each service provider interfacing with a student may communicate with system 100 using an electronic computing device to communicate over a network.

In various embodiments, service providers may interface with system 100 via smartphone 102, tablet 104, laptop 106, or any other suitable computing device 108. Suitable computing devices for service providers interfacing with system 100 may include a computer or processor, or a set of computers/processors, such as those commonly installed in personal computers. However, other types of computing units or systems may be also be used including laptops, notebooks, hand held computers, personal digital assistants, cellular phones, smart phones (e.g., iPhone®, Blackberry®, Android®, etc.) tablets, wearables, Internet of Things (IoT) devices, voice personal assistant (VPA, e.g. Amazon Echo®, Google Home®, etc.) or any other device capable of sending and/or receiving data over the network 101. One or more of the aforementioned computing devices may be in electronic communication with an application server 110 over network 101.

In various embodiments, application server 110 may include one or more computing devices described above, rack mounted servers, and/or virtual machines providing load balancing, application services, web services, data query services, data transfer services, reverse proxy services, or otherwise facilitating the delivery and receipt of student data across network 101. Application server 110 may also communicate with database 112 across network 103 to access student data and deliver student data to service providers based on applicable access controls or permissions.

In various embodiments, network 103 may be any suitable electronic link capable of carrying communication between two or more computing devices. For example, network 103 may include local area network (LAN) using TCP/IP communication separated from the Internet by a firewall or other security devices. A network may thus be isolated from the Internet to some degree. Network 101 may include a wide area network (WAN) using communication over the Internet. Application servers 110 may be in communication with a database 112 over network 103. Application servers 110 may also communicate across the Internet with a client device such as smartphone 102, for example, and application servers 110 may communicate with database 112 across a private LAN isolated from the Internet by a firewall and/or other security measures.

In various embodiments, smartphone 102, tablet 104, laptop 106, or any other suitable computing device 108 described herein may run a web application or native application to communicate with application server 110. A native application may be installed on a computing device via download, physical media, or an app store, for example. The native application may utilize the development code base provided for use with the operating system and capable of performing system calls to manipulate the stored and displayed data on the computing device and communicates with application server 110. A web application may be web browser compatible and written specifically to run on a web browser. The web application may thus be a browser-based application that operates in conjunction with application server 110.

In various embodiments, the application running on smartphone 102, tablet 104, laptop 106, or any other suitable computing device 108 described herein may be in communication with application server 110 to support real-time updates. Data pertaining to an individual student may synchronize across the devices used by the various service providers that interact with the individual student by way of each device retrieving data from application server 110. Service providers may thus indirectly keep each other up-to-date by entering service events, results, and other data into the application running on their mobile device for transmission to application server 110. Application server 110 serves the output to applications running on the various computing devices described herein.

In various embodiments, application server 110 may apply access permissions to restrict the data transmitted to the computing devices. Service providers may be authenticated on the application running on their mobile device using a user name, password, dual factor authentication, private cryptographic key, one-time password, security question, biometrics, or other suitable authentication techniques. The authenticated service provider may have an assigned group of students and/or patients with whom he works.

In various embodiments, database 112 comprises an educational plan associated with each student of which student data is stored. The educational plan may contain goals derived from an IEP for a given child, as well as data collected in the course of education that tracks progress toward those goals. The educational plan may contain goals derived from an Individuated Family Service Plan (IFSP) for a given child, as well as data collected in the course of education that tracks progress toward those goals. An IFSP is a document used to coordinate services in Early Intervention programs for families that have children with disabilities. For example, an educational plan can comprise a plurality of educational or treatment goals designed to accommodate a particular child. Treatment goals can comprise, for example, any objective or goal related to improving the health, quality of life, or treatment of a disease, disorder, or disability. Educational goals can comprise, for example, the acquisition of any skill for a given child. For example, educational goals may include mastery of any subject in the core curriculum of any state, a curriculum from the Common Core State Standards Initiative, and/or the Extended Core Curriculum for children with various disabilities, and any subgoals therefrom. Accordingly, educational goals could relate to general educational goals in the areas of literacy, math, history, geography, foreign languages, etc., but may also relate to life skills for students with disabilities. For example, mastery of Braille for blind students may be an educational goal having hundreds or thousands of subgoals on the path to mastery. In that regard, educational subgoals may be nested under larger educational goals. In various embodiments, treatment goals can be short-term goals, such as goals to be achieved in about one month and six months, medium-term goals, such as goals to be achieved in about six months and two years, or long-term goals, such as goals to be achieved in more than two year.

Further example educational goals may comprise mastery of American Sign Language, mastery of urban travel for blind/visually impaired students, low vision driving, the Nemeth Braille code, cooking for blind/visually impaired students, and use of low visions aids for visually impaired students, among others. In various embodiments, database 112 manages an educational plan for each student, updating the educational plan as goals are completed.

In a further example, services that are reimbursable from private or public health insurance plans are also included as part of an educational plan. For example, a student may need assistance in toileting, medication administration, or other healthcare related service. The educational plan may thus support a number of such events. Records of these events may be stored, including time stamps, time expending during service, notes, and student demographic data. In various embodiments, as described herein, the events may be output in a format acceptable to private or public health insurance plans, including, for example, an XML, format.

With initial reference to FIG. 2A, a method 220 for coordinating information pertaining to providing service and/or treatment to individual students and/or patients, in accordance with various embodiments is illustrated. In various embodiments, method 220 comprises a step 222 of receiving a first service event data. For example, step 222 can comprise a service provider entering a first service event data in to a device such as smartphone 102, tablet 104, laptop 106, or any other suitable computing device 108. In various embodiments, the first service event data comprises one or more of a first service recipient, a first service event, a first geographic location, and a first service time, and a first duration.

In various embodiments, a first service event can comprise any therapy, treatment, instruction, or other service provided by a service provider to a student. In various embodiments, a first service event can comprise one or more treatment steps of an educational plan, as described above. For example, a blind student may have an educational goal of learning to read Braille, and a first service event can be any step or steps that progress the student towards the goal of learning to read Braille. Any first service event that contributes to or progresses towards an educational goal is within the scope of the present disclosure.

A first service event can also comprise, for example, a therapeutic or service performed by a service provider to a student or patient that does not correspond to an educational goal. For example, particular service events may be needed by students with a disease, disability, or disorder that help maintain the quality of life of the student, but do not contribute to a particular treatment goal (e.g., recurring or “routine” services provided to the student). Such services can comprise, for example, eating or feeding, dressing, toileting, physical manipulation (transferring or positioning the body of the patient/student), grooming, and service of assistive devices. Any first service event that provides a therapeutic, educational, or health benefit to a student, despite not progressing towards or corresponding with an educational goal, is within the scope of the present disclosure.

In various embodiments, one or more components of first service event data can be automatically determined by a device. For example, smartphone 102, tablet 104, laptop 106, or any other suitable computing device 108 can determine one or more of a first geographic location, a first service time, and a first duration of the first service event. For example, the service provider utilizing method 220 may arrive at a location to perform a first service event. The device may automatically determine the location (for example, using a global positioning system sensor of smartphone 102, tablet 104, laptop 106, or any other suitable computing device 108) and the duration of the service provided. Further, the device may determine at what time the service was performed (i.e., the first service time), and the duration of the service performed (i.e., the first duration). These components of first service event data can be combined with data entered by the service provider to comprise the first service event data.

Method 220 can further comprise, for example, a step 224 of authenticating a service provider account. In various embodiments, step 224 comprises transmitting user identification credentials from, for example, smartphone 102, tablet 104, laptop 106, or any other suitable computing device 108, to an application server such as application server 110 to determine the identity of the user and service provider. The identity of the user and service provider can correspond to a service provider account. In various embodiments, each service provider account comprises an access profile, which determines what information from database 112 is accessible to the service provider to whom the access profile corresponds. For example, an access profile may comprise a list of students to which the service provider provides treatment or services.

In various embodiments, method 220 further comprises a step 226 of parsing the first service event data. For example, step 226 can comprise parsing one or more components of first service event data, such as first geographic data, first service type data, first service time, and/or first duration. First service event data may be arranged in a structured messaging format, such as XML or an object in an object orientated programming language, or an object in a relational database. The parsing may logically separate one or more constituent data. The parsing may include identification of a potential first service event based on identification of a calendar or schedule stored on smartphone 102, tablet 104, laptop 106, or any other suitable computing device 108. In that regard, the parsed data may include a potential first service event based on or derived from the calendar.

In various embodiments, method 220 further comprises a step 228 of creating a metadata field for the potential first service event. The metadata field may comprise one or more constituent data from the first service event data, such as first geographic data, first service time, and/or first duration. The metadata field may also contain the schedule data. In various embodiments, the metadata field may comprise the potential first service event first geographic data, and first service type data.

In various embodiments, method 220 further comprises a step 230 of linking the metadata field with a step in a first service event that corresponds to the potential first service event. In this manner, step 230 may link the potential first service event to a first service event through the metadata field. Since the metadata field may comprise the potential first service event, first geographic data, and first service type data, the linking to the first service event may be made by, for example, by appropriate querying. Step 226 can comprise determining, by comparing components of first event service data to a schedule, a potential first service event. For example, in various embodiments, the service provider may fail to enter the service event itself, and step 230 can determine one or more potential service events by comparing components of first service event data to a schedule or calendar.

In various embodiments, step 230 comprises linking, for example, by application server 110, the first service event data to educational plans stored, for example, in database 112. Step 230 can comprise accessing educational plans associated with the service provider account of step 224, and linking first service event data to an individual educational plan (for example, the educational plan associated with first service recipient of first service event data) educational plans to determine if the first service event comprises a step with the educational plan.

In various embodiments, method 220 further comprises a step 230 of associating the first service event data with one or more treatment steps. For example, the associating can by adding the first service event data to a data object stored in a database that has a key field linked to the one or more treatment steps. The key field may be obtained directly from a database or may be marshalled into a data packet. For example, step 230 can comprise comparing the first service event data with one or more steps or goals of the educational plan (for example, the educational plan corresponding to the first service recipient) to determine if the first service event should be associated with the educational plan.

Method 220 can further comprise, for example, a step 232 of updating educational plan to include first service event data. In various embodiments, the educational plan corresponding with the first service recipient is updated to reflect the completion or partial-completion of one or more educational steps and/or goals.

In various embodiments, method 220 further comprises a step 234 of creating a first medical billing data. For example, step 234 can comprise comparing the first service event data (including the first service event) to a database (such as, database 112) which comprises pricing data. Step 234 can comprise associating the first service event data with one or more billing events within the pricing data to create a first medical billing data. The first medical billing data can be associated with the first service recipient, and transmitted to the payment provider for the first service recipient (for example, a health insurance entity, whether public or private) on a periodic basis, such as daily, weekly, and/or monthly.

With initial reference to FIG. 2B, a method 221 for coordinating information pertaining to providing service and/or treatment to individual students and/or patients, in accordance with various embodiments is illustrated.

In various embodiments, method 221 comprises a step 223 of determining a geographic data and a time data. For example, step 223 can comprise a service provider entering a geographic data and/or a time data in to a device such as smartphone 102, tablet 104, laptop 106, or any other suitable computing device 108. In various embodiments, the geographic data and/or the time data can be automatically determined by the device. For example, smartphone 102, tablet 104, laptop 106, or any other suitable computing device 108 can determine one or more of a first geographic location, a first service time, and a first duration of the first service event. For example, the service provider utilizing method 220 may arrive at a location to perform a first service event. The device may automatically determine the location (for example, using a global positioning system sensor or information from a cellular phone network) and the duration of the service provided. Further, the device may determine at what time the service was performed (e.g., a first service time), and the duration of the service performed (e.g., the first duration). These data can be combined with data entered by the service provider.

Method 221 can further comprise, for example, a step 225 of determining a proposed treatment event (also called a treatment step). In various embodiments, step 225 comprises comparing first geographic data and/or first time data (including first service time, and/or first duration), to a calendar or schedule stored on smartphone 102, tablet 104, laptop 106, or any other suitable computing device 108 and/or a database (such as database 112) to determine a first proposed treatment event.

In various embodiments, method 221 further comprises a step 227 of authenticating a service provider user identity. For example, step 227 can comprise transmitting user identification credentials from, for example, smartphone 102, tablet 104, laptop 106, or any other suitable computing device 108, to an application server such as application server 110 to determine the identity of the user and service provider. The identity of the user and service provider can correspond to a service provider account. In various embodiments, each service provider account comprises an access profile, which determines what information from database 112 is accessible to the service provider to whom the access profile corresponds. For example, an access profile may comprise a list of patients or students to which the service provider provides treatment or services. Authentication may occur via any method described herein, such as username/password, dual factor authentication, private cryptographic key, Kerberos authentication, or the like.

Method 221 can further comprise, for example, a step 229 of confirming the proposed treatment event. In various embodiments, the proposed treatment event of step 225 can be displayed on smartphone 102, tablet 104, laptop 106, or any other suitable computing device 108, and the service provider queried to determine if the proposed treatment event has been performed. If the service provider indicates that the proposed treatment event occurred, the device can then store a confirmed treatment event.

In various embodiments, method 221 further comprises a step 231 of comparing the confirmed treatment event to an educational plan. In various embodiments, step 231 comprises comparing, for example, by application server 110, the confirmed treatment event to educational plans stored, for example, in database 112. Step 231 can comprise accessing educational plans associated with the service provider account of step 227, and comparing first service event data to an individual educational plan (for example, the educational plan associated with first service recipient of first service event data) educational plans to determine if the first service event comprises a step with the educational plan.

Method 221 can further comprise, for example, a step 233 of updating educational plan to include first service event data. In various embodiments, the educational plan corresponding with the first service recipient is updated to reflect the completion or partial-completion of one or more treatment steps.

In various embodiments, method 221 further comprises a step 235 of creating a first medical billing data. For example, step 235 can comprise comparing the confirmed treatment event to a database (such as, database 112) which comprises pricing data. Step 235 can comprise associating the confirmed treatment event with one or more billing events within the pricing data to create a first medical billing data. The first medical billing data can be associated with the first service recipient, and transmitted to the payment provider for the first service recipient (for example, a health insurance entity, whether public or private) on a periodic basis, such as daily, weekly, and/or monthly

With initial reference to FIG. 3, a mobile device 350 displaying a graphical user interface (“GUI”) 352 is illustrated. With reference back to FIG. 1, mobile device 350 can comprise, for example, smartphone 102, tablet 104, laptop 106, or any other suitable computing device 108 of system 100. GUI 352 can, for example, display a list of a number of students whose information is stored in database 112. In various embodiments, the information displayed to a service provider via GUI 352 corresponds to one or more of the students to whom the service provider has access to through application server 110. Stated another way, GUI 352 can display information that is associated with the account of the service provider. With reference back to FIGS. 2A, step 224 of method 200 can authenticate the account of a service provider, and once authenticated, corresponding information can be displayed on GUI 352.

With initial reference to FIG. 4, a mobile device 450 displaying a GUI 452 is illustrated. GUI 452 can display information about a particular student or patient whose information is stored in database 112. For example, GUI 452 can display the name, history of service events performed, and one or more educational goals for a particular student.

With initial reference to FIG. 5, a mobile device 550 displaying a GUI 552 is illustrated. Similar to GUI 452, GUI 552 can display information about a particular student or patient whose information is stored in database 112. In various embodiments, GUI 552 can display upcoming service events for the particular student such as, for example, in a “to do” list.

With initial reference to FIG. 6, a mobile device 650 displaying a GUI 652 is illustrated. Similar to GUI 452 and GUI 552, GUI 652 can display information about a particular student or patient whose information is stored in database 112. In various embodiments, GUI 652 can display service events performed on a particular day, such as, for example, in a “daily activity” list. A confirmation button may be displayed to confirm data entered in GUI 652.

With initial reference to FIG. 7, a mobile device 750 displaying a GUI 752 is illustrated. GUI 752 can, for example, display information pertaining to the service provider, which is stored in database 112. In various embodiments, GUI 752 can display service events or tasks scheduled to be performed by the service provider on a particular day, such as, for example, in a “to do” list.

With initial reference to FIG. 8, a mobile device 850 displaying a GUI 852 is illustrated. GUI 852 can display information about one or more students associated with a service provider, as well as information pertaining to the service provider, which is stored in database 112. In various embodiments, GUI 852 can display service events scheduled and/or performed over a specified time frame, such as, for example, a month of the year. As shown, FIG. 8 illustrates GUI 852 if the service provider selects the “Nov” button to show the service events performed in November. The service events may be sorted in chronological order. For example, on November 17th, GUI 852 may show that the service provider provided three different service events for David Donaldson, as well one or more service events for Peter Peterson. Each service event may include a duration and specific activity, such as 30 minutes for a Direct Service—Physical Therapy Evaluation, 30 minutes for an IFSP Meeting, and 30 minutes for an Indirect Service. Each service event may also display any notes inserted by the service provider. For example, on November 29th, the service provider may have entered the notes “Preparing for day” for an service event of 30 minutes Administrative Time. In order to view service events provided in December, the service provider may select the “December” button. Additionally, the service provider may select the “Filter” button to filter the service events by date, student, type of service event, keywords, etc.

With initial reference to FIG. 9A, a mobile device 960 displaying a GUI 952 is illustrated. GUI 952 may allow a service provider to add a new service event. The service provider may enter information about the particular service event, including one or more of the student name, service event, time period over which the service event was performed, and/or other information relevant to a particular service event. For example, the service provider may type in a student name, or select a student from a list. The service provider may press a “Select Student” button to view of list of students from which to select. An “Add” button may allow the service provider to add additional students when a service event involves more than one student. The service provider may type in a service activity, or the service provider may select an activity from a list of predefined activities. In various embodiments, in response to clicking on a “Select Activity” button, a list of available activities may be displayed, as shown in FIG. 9B. The service provider may select or type a goal for the service event. The service provider may enter notes for the service event, such as “Worked on sitting up.” The service provider may save the service event, and the service event may be stored in database 112.

With initial reference to FIG. 9B, the mobile device 950 showing a list 954 of service event types is illustrated according to various embodiments. In response to the service provider selecting the “Select Activity” field shown in FIG. 9A, the list 954 may pop up. The list may include various available service activity types, such as Direct Service, Co Treat Direct, Indirect Service, Parent Contact, Student Absent, Student Unavailable, Provider Cancel, Compensatory, Administrative Time, etc. The service provider may select one of the available service event types, and the “Select Activity” field shown in FIG. 9A may populate with the selected service event type.

With initial reference to FIG. 9C, The mobile device 950 displaying a GUI 956 for editing a service event is illustrated. The service provider may select a stored service event, such as by selecting a service event listed as shown in FIG. 8. GUI 956 can display information about the particular service event, which is stored in database 112. In various embodiments, GUI 956 can allow the service provider to enter and edit information about the particular service event, including one or more of the student name, service event, time period over which the service event was performed, and/or other information relevant to a particular service event. The service provider may save or discard the edits to the service event.

With initial reference to FIG. 10, a mobile device 1050 displaying a GUI 1052 is illustrated. GUI 1052 can display information about one or more students associated with a service provider, which is stored in database 112. In various embodiments, GUI 1052 can display the status of a number of students, including their attendance at a particular service event such as, for example, a class or seminar.

With initial reference to FIG. 11, a mobile device 1150 displaying a GUI 1152 is illustrated. GUI 1152 can display information about one or more students associated with a service provider, which is stored in database 112. In various embodiments, GUI 1152 can allow the service provider to enter and edit information about the status of the particular students, including their attendance at the class or seminar, thereby tracking attendance of the students. Further, GUI 1152 can allow the service provider to enter and edit details of service events provided to the students, such as the type of service event and/or the duration of the service event.

With initial reference to FIG. 12, a mobile device 1250 displaying a GUI 1252 for a student report is illustrated. The student report may be viewed by a parent or a service provider. The student report may provide a summary of all service events which have been provided to the student. The student may have a primary goal as part of an IEP which includes many subgoals. For example, mastery of Braille for blind students may be an educational goal having hundreds or thousands of subgoals on the path to mastery. In that regard, educational subgoals may be nested under larger educational goals. In various embodiments, treatment goals can be short-term goals, such as goals to be achieved in about one month and six months, medium-term goals, such as goals to be achieved in about six months and two years, or long-term goals, such as goals to be achieved in more than two year.

The student may have multiple service providers, the service providers may change over time, and/or the student may move or change school districts. By combining all of the service events and subgoals in GUI 1252, the parent or service provider may be able to quickly and easily view the status of the student's progress. In various embodiments, a subgoal may be a service event provided to the student, such as 30 minutes of the service provider reading aloud to the student while the student follows along in Braille, or the subgoal may be a specific result accomplished by the student, such as the student successfully reading a sentence in Braille. In various embodiments, the subgoals may be ordered or numbered, such as one through one hundred, with progressively more challenging subgoals having the higher numbers. Once the student completes all one hundred subgoals, the student has achieved the primary goal. However, the student may complete the subgoals out of order. In various embodiments, the parent or service provider may view a list of all subgoals required to complete the primary goal, and each subgoal may indicate its status, such as complete, incomplete, or in progress. The status of the various subgoals may be synchronized across devices used by different service providers and parents.

With initial reference to FIG. 13, a mobile device 1350 displaying a GUI 1352 for updating and tracking subgoals for students and/or patients, in accordance with various embodiments. Goals may be divided into multiple disciplines. As illustrated in FIG. 13, disciplines may include Expanded Core Curriculum, Gross Motor, and Language. Other possible disciplines may include Social, Cognitive/Academic, Learning Disability, Behavior/Emotional Disability, Hearing Impairment, Deafblind, Fine Motor, etc. Goals may be further classified in subjects. In response to the user selecting a discipline, the GUI 1352 may display subjects within the discipline.

With initial reference to FIG. 14, the GUI 1352 is illustrated with a goal selected. As shown by the shading, the user may have selected the Expanded Core Curriculum subgoal. In response, the GUI 1352 may display the subjects of Compensatory and Communication Modes, Vision: Cortical Visual Impairment, Vision: Functional Use, Recreation and Leisure, and Independent Living. Each subject may display the number of goals included in the subject, as well as the number of completed goals in the subject. For example, for the Compensatory and Communication Modes subject, zero out of four goals have been completed.

The user may have selected the Compensatory and Communication Modes top subject. In the adjacent column, the GUI 1352 may display the four goals contained in the Compensatory and Communication Modes subject, which may be Braille Literacy, Study and Organization, Use of Adapted Materials and Specialized Equipment, and Print Literacy. Each goal may comprise multiple subgoals. In various embodiments, one goal may comprise hundreds or thousands of subgoals. For example, the goal may be for a student to learn Braille. However, that goal may be divided into hundreds of smaller steps that lead toward the larger goal. As illustrated by the shading, the user may have selected the Braille Literacy goal. In the adjacent column, the various subgoals may be displayed. The subgoals may include Enjoys Touch, Responds to Touch, Brings Hands to Mouth, Hands—Tactile Input, Hands Interact with Objects, Explore New Object, Search for Object, Recognize Object, Explore Book with One Hand, Explore Book with Two Hands, etc. The user may scroll down on the GUI 1352 to view additional subgoals. In various embodiments, the subgoals may be numbered, with higher numbers indicating generally more advanced subgoals.

The user may select a different goal. For example, the user may select the Print Literacy goal, and the subgoals in the adjacent column may repopulate with the Print Literacy subgoals, which may include Interested in Books with Textures or Moveable Parts; Examines “Story Box” (tactual) Items as Story is Read; Locates Parts of Books: Front Cover, Pages; Actively Examines the Pages of Tactual Books; Independently Explores Homemade Books with Real Objects, Textures; etc.

With initial reference to FIG. 15, the GUI 1352 is illustrated with a subgoal selected. The user may have selected the second subgoal, Responds to Touch. In response, the GUI 1352 may display options associated with the subgoal, including Baseline, Target, Revisit, and IEP Goal. The Baseline may indicate the starting point for the student. The Target may allow the user to set a subgoal as a target subgoal. For example, the Hands Interact with Objects subgoal may be a target subgoal which is accomplished after the first four subgoals are completed. The Revisit may allow the provider or student to return to a subgoal, perhaps if the student has shown difficulty accomplishing subsequent subgoals, the student may need to return to previously completed subgoals in order to improve the level of mastery. The IEP Goal may allow the user to update the student's progress through the IEP.

With initial reference to FIG. 16, a GUI 1652 is illustrated for updating a student's progress through the subgoals. In various embodiments, the GUI 1652 may be displayed in response to the user selecting the IEP button shown in FIG. 15. Each of the subgoals may require more than instance in order to be completed. For example, the Enjoys Touch subgoal may require the student to complete the exercise 2 times in order for the subgoal to be considered complete. As illustrated, the student may have completed two out of the three iterations. The user may select one of the subgoals and enter an outcome.

With initial reference to FIG. 17, a GUI 1752 is illustrated for updating a subgoal. the use may have selected the Enjoys Touch subgoal as shown in FIG. 16. The user may select whether the student Accomplished or Did not do the subgoal. The user may then cancel or save the entry. In response to the user saving an entry, the database may update the student's progress with a completed iteration of the subgoal.

With initial reference to FIG. 18, a GUI 1852 is illustrated indicating that a subgoal has been achieved. For example, in response to the user completing all three of the three required iterations for Enjoys Touch, the GUI 1852 may display a congratulatory message that the subgoal has been achieved. The system may transmit a congratulatory message, such as an email or SMS message, to a student, parent, service provider, or other entity. Thus, the parent may be notified that the student is making progress. Thus, parents may be made aware that the student is progressing in the right direction, even if the subgoals are minor steps to a larger overall goal.

With initial reference to FIG. 19, a mobile device 1950 displaying a GUI 1952 for a menu is illustrated. The menu may include options such as service events, students, reports, to dos, history, help, logout, etc. Selecting any of the options may take the user to the corresponding GUI. For example, selecting “Service Events” may take the user to the Service Events GUI shown in FIG. 8. Selecting “Students” may take the user to the “Caseload” GUI shown in FIG. 3. Selecting “Reports” may take the user to the “Reports” GUI shown in FIG. 14. Selecting “To Dos” may take the user to the “To Dos” GUI shown in FIG. 7.

Referring to FIG. 20, a mobile device 2050 displaying a GUI 2052 for a mileage report is illustrated. The mileage report may include information such as date, location, miles driven, and reimbursement amount. In various embodiments, the reimbursement amount may be calculated by multiplying the miles driven by a reimbursement rate per mile. In various embodiments, the application on the provider's device may automatically generate the mileage report. The application on the device or the application server may obtain the geolocation of the device. In response to the service provider arriving at or leaving a location, the application may record the time and location. For example, the service provider may arrive at 1234 56th St at 7:26 AM. The application may measure the distance from the previous location and determine that the service provider drove 3.2 miles. In response to the service provider arriving at 4567 E Shea Blvd, the application may calculate the distance from 1234 56th St to 4567 E Shea Blvd and generate the mileage information. The information may be transmitted from the mobile device to the application server. In various embodiments, the application may request driving distance information from a third party maps provider, such as Google™ Maps, via an application programming interface in order to obtain the distance between two locations. The GUI 2052 may prompt the service provider to enter the service event type, and the service provider may enter the type, such as Admin Time.

Although the mobile devices in the various figures are described with different reference numerals, in various embodiments a single mobile device may provide the GUIs shown and described with reference to the various FIGs.

In various embodiments, the system and method may include a graphical user interface for dynamically relocating/rescaling obscured textual information of an underlying window to become automatically viewable to the user. By permitting textual information to be dynamically relocated based on an overlap condition, the computer's ability to display information is improved. More particularly, the method for dynamically relocating textual information within an underlying window displayed in a graphical user interface may comprise displaying a first window containing textual information in a first format within a graphical user interface on a computer screen; displaying a second window within the graphical user interface; constantly monitoring the boundaries of the first window and the second window to detect an overlap condition where the second window overlaps the first window such that the textual information in the first window is obscured from a user's view; determining the textual information would not be completely viewable if relocated to an unobstructed portion of the first window; calculating a first measure of the area of the first window and a second measure of the area of the unobstructed portion of the first window; calculating a scaling factor which is proportional to the difference between the first measure and the second measure; scaling the textual information based upon the scaling factor; automatically relocating the scaled textual information, by a processor, to the unobscured portion of the first window in a second format during an overlap condition so that the entire scaled textual information is viewable on the computer screen by the user; and automatically returning the relocated scaled textual information, by the processor, to the first format within the first window when the overlap condition no longer exists.

A network may be unsecure. Thus, communication over an unsecure network may utilize data encryption. Encryption may be performed by way of any of the techniques now available in the art or which may become available. Commonly known examples include, Twofish, RSA, El Gamal, Schorr signature, DSA, PGP, PKI, GPG (GnuPG), and symmetric and asymmetric cryptography systems. System 100 may use public/private key encryption in various embodiments to take advantage of the in-person relationship between service providers and the organization maintaining application server 110. For example, each provider may have a private key entered into an application running on their computing device without communicating the private key over the Internet.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, the Internet, point of interaction device (point of sale device, personal digital assistant (e.g., iPhone®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein.

The term “cloud” may include cloud based delivery, for example the services commonly referred to as Software as a Service (SaaS), Platform as a Service (PaaS), and Infrastructure as a Service (IaaS). IaaS can refer to a user renting the use of infrastructure resources that are needed during a specified time period. IaaS providers can offer storage, networking, servers or virtualization resources from large pools, allowing the users to quickly scale up by accessing more resources as needed. Examples of IaaS can include infrastructure and services provided by AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., and the like. PaaS providers can offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., and Google App Engine provided by Google Inc. SaaS providers can offer the resources that PaaS provides, including storage, networking, servers, virtualization, operating system, middleware, or runtime resources. In various embodiments, SaaS providers can offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS can also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Firewalls, as discussed herein, may include any hardware and/or software suitably configured to protect various components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewalls may be integrated within a web server or any other components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts.

Middleware, as described herein, may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE MQTM (formerly MQSeries) by IBM®, Inc. (Armonk, N.Y.) is an example of a commercially available middleware product. An Enterprise Service Bus (“ESB”) application is another example of middleware.

Systems, methods, and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS® NT®, WINDOWS® 95/98/2000®, WINDOWS® XP®, WINDOWS® Vista®, WINDOWS® 7®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet account), a communications port, a Personal Computer Memory Account International Association (PCMCIA) slot and account, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

Any databases discussed herein may include relational, non-relational, hierarchical, graphical, or object-oriented structure and/or any other database configurations including various big data products available from the Apache Software Foundation as described above. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address (123.56.192.225). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method comprising:
receiving, by a processor and from a mobile device, a first service event data comprising a first service event, a first geographic location, and a first duration;
parsing, by the processor, the first service event data to a first educational plan, wherein the first educational plan comprises a plurality of treatment steps to reach an educational goal, and wherein the first educational plan is stored in an educational plan relational database and is associated with a first student, wherein the parsing identifies a potential first service event;
creating, by the processor, a metadata field for the potential first service event;
linking, by the processor, the metadata field with a step in the potential first service event to identify the first service event;
associating, by the processor, the first service event of the first service event data with one or more of the plurality of treatment steps of the first educational plan;
receiving, by the processor, a second service event data comprising a second service event, a second geographic location, and a second duration;
linking, by the processor, the second service event data to a second educational plan; and
associating, by the processor, the second service event of the second service data with one or more of a plurality of treatment steps of the second educational plan.

2. The method of claim 1, wherein the step of receiving the first service event data comprises entering, at the mobile device, at least one of the first service event and the first duration in to a first mobile device, and transmitting, by the first mobile device, the first service event data to the processor.

3. The method of claim 1, wherein the first service event data further comprises a service note created by a service provider.

4. The method of claim 1, wherein the first geographic location of the first service event data is determined by a component of a first mobile device.

5. The method of claim 1, further comprising authenticating, by the processor, a service provider account.

6. The method of claim 3, wherein the service provider comprises at least one of an itinerant service provider, a classroom instructor, a physician, a nurse practitioner, a nurse, a teacher of the visually impaired, a teacher of the deaf, a physical therapist, or an occupational therapist.

7. The method of claim 1, wherein the parsed data identifies the potential first service event derived from a calendar.

8. The method of claim 1, wherein the first service event comprises at least one of a therapeutic treatment or an instructional event.

9. A system comprising:
a processor,
a tangible, non-transitory memory configured to communicate with the processor,
the tangible, non-transitory memory having instructions stored thereon that, in response to execution by the processor, cause the processor to perform operations comprising:
receiving, by a processor and from a mobile device, a first service event data comprising a first service event, a first geographic location, and a first duration;
parsing, by the processor, the first service event data to a first educational plan, wherein the first educational plan comprises a plurality of treatment steps to reach an educational goal, and wherein the first educational plan is stored in an educational plan relational database and is associated with a first student, wherein the parsing identifies a potential first service event;
creating, by the processor, a metadata field for the potential first service event;
linking, by the processor, the metadata field with a step in the potential first service event to identify the first service event;
associating, by the processor, the first service event of the first service event data with one or more of the plurality of treatment steps of the first educational plan;
receiving, by the processor, a second service event data comprising a second service event, a second geographic location, and a second duration;
linking, by the processor, the second service event data to a second educational plan; and
associating, by the processor, the second service event of the second service data with one or more of a plurality of treatment steps of the second educational plan.

10. The system of claim 9, wherein the first service event data further comprises a service note created by a service provider.

11. The system of claim 9, wherein the first geographic location of the first service event data is determined automatically by a component of a first mobile device.

12. The system of claim 9, wherein the operations further comprise authenticating, by the processor, a service provider account.

13. The system of claim 10, wherein the service provider comprises to one of a physician, an itinerant service provider, a classroom instructor, a physician, a nurse practitioner, a nurse, a teacher of the visually impaired, a teacher of the deaf, a physical therapist, or an occupational therapist.

14. The system of claim 9, wherein the operations further comprise comparing, by the processor, the first service event data to a schedule.

15. The system of claim 9, wherein the first service event comprises at least one of a therapeutic treatment or an instructional event.

16. An article of manufacture including a non-transitory, tangible computer readable storage medium having instructions stored thereon that, in response to execution by a computer based system, cause the computer based system to perform operations comprising:
receiving, by the computer based system, a first service event data comprising a first service event, a first geographic location, and a first duration;
comparing, by the computer based system, the first service event data to a first educational plan, wherein the first educational plan comprises a plurality of treatment steps to reach a treatment goal, and wherein the first educational plan is stored in an educational plan relational database and is associated with a first student;
associating, by the computer based system, the first service event of the first service event data with one or more of the plurality of treatment steps of the first educational plan;
receiving, by the computer based system, a second service event data comprising a second service event, a second geographic location, and a second duration;
comparing, by the computer based system, the second service event data to a second educational plan; and
associating, by the computer based system, the second service event of the second service data with one or more of a plurality of treatment steps of the second educational plan.

17. The article of manufacture of claim 16, wherein the first service event data further comprises a service note created by a service provider.

18. The article of manufacture of claim 17, wherein the service provider comprises to one of an itinerant service provider, a classroom instructor, a physician, a nurse practitioner, a nurse, a physical therapist, and an occupational therapist.

19. The article of manufacture of claim 16, wherein the first geographic location of the first service event data is determined automatically by a component of a first mobile device.

20. The article of manufacture of claim 16, wherein the operations further comprise comparing, by the computer based system, the first service event data to a schedule.
